(19) United States
(12) Patent Application Publication
(10) Pub. No.: US 2011/0193691 A1
(43) Pub. Date: Aug. 11, 2011

(54) VIBRATION MODULE AND VIBRATION METHOD

(75) Inventors: Ming-Feng Liu, Taipei City (TW); Yi-Hung Shen, Taipei City (TW); Shih-Wei Li, Taipei City (TW); Chien-Chun Wu, Taipei City (TW)

(73) Assignee: COMPAL ELECTRONICS, INC., Taipei City (TW)

(21) Appl. No.: 12/768,735

(22) Filed: Apr. 28, 2010

(30) Foreign Application Priority Data
Feb. 11, 2010 (TW) 99104481

(51) Int. Cl. G08B 6/00

(52) U.S. Cl. 340/407.2

(57) ABSTRACT

A vibration module is suitable for an electronic device. The vibration module includes a vibration element, a plurality of pressing units, and a vibration regulating circuit. The pressing units are disposed on the electronic device and respectively have a coordinate relative to the vibration element. The vibration regulating circuit is disposed in the electronic device and coupled to the vibration element and the pressing units. The vibration regulating circuit calculates a distance between one of the pressing units and the vibration element and regulates an output vibration strength of the vibration element based on the distance.

### CROSS-REFERENCE TO RELATED APPLICATION

This application claims the priority benefit of Taiwan application serial no. 99104481, filed on Feb. 11, 2010. The entirety of the above-mentioned patent application is hereby incorporated by reference herein and made a part of specification.

### BACKGROUND OF THE INVENTION

1. Field of the Invention

The invention relates to a vibration module and a vibration method. More particularly, the invention relates to a vibration module and a vibration method applicable for regulating an output vibration strength of a vibration element based on a distance.

2. Description of Related Art

In a conventional vibration module, when a distance from a pressing unit to a vibration element increases, an amplitude of a vibration wave transmitted to the pressing unit decreases, such that a user is rather unlikely to detect an output vibration strength of the vibration element. By contrast, when the distance from the pressing unit to the vibration element decreases, the amplitude of the vibration wave transmitted to the pressing unit increases, and the user can easily detect the output vibration strength of the vibration element. Consequently, even though the output vibration strength of the vibration element is approximately the same, on the user end, the degrees of vibration may vary.

In FIG. 6A of U.S. Pat. No. 6,337,678, a touch-pad unit is divided into a plurality of regions by a vibrator array. When a processor detects a signal indicating one of the regions is pressed, a vibration feedback is directly provided by a vibrator disposed below the region.

### SUMMARY OF THE INVENTION

The invention is directed to a vibration module and a vibration method applicable for regulating an output vibration strength of a vibration element based on a distance.

In this invention, a vibration module suitable for an electronic device is provided. The vibration module includes a vibration element, a plurality of pressing units, and a vibration regulating circuit. The pressing units are disposed on the electronic device. The vibration regulating circuit is disposed in the electronic device and coupled to the vibration element and the pressing units. The vibration regulating circuit calculates a distance between each of the pressing units and the vibration element and regulates an output vibration strength of the vibration element based on the distance.

In this invention, a vibration method suitable for an electronic device is provided. The electronic device has a vibration element and a plurality of pressing units. The vibration method includes: touching one of the pressing units, calculating a distance between the touched one of the pressing units and the vibration element, and regulating an output vibration strength of the vibration element based on the distance.

According to an embodiment of the invention, the vibration regulating circuit includes a coordinate processing unit, a calculation unit, and a modulation control unit. The coordinate processing unit is disposed in the electronic device and receives a coordinate signal output by one of the pressing units. The calculation unit is coupled to the coordinate processing unit, and the calculation unit calculates a weighted index based on a distance from the one of the pressing units to the vibration element. The modulation control unit is disposed in the electronic device and coupled to the calculation unit and the vibration element. Besides, the modulation control unit receives the weighted index and regulates the output vibration strength of the vibration element based on the weighted index.

According to an embodiment of the invention, the electronic device has a keyboard, and the pressing units are disposed on the keyboard.

According to an embodiment of the invention, the pressing units include a plurality of keys.

According to an embodiment of the invention, the weighted index decreases when the distance from the one of the pressing units to the vibration element decreases.

According to an embodiment of the invention, the weighted index is represented as a percentage.

According to an embodiment of the invention, the output vibration strength of the vibration element increases when the weighted index increases.

According to an embodiment of the invention, the vibration method further includes receiving a coordinate signal output by one of the pressing units in the step of touching one of the pressing units.

According to an embodiment of the invention, in the step of regulating the output vibration strength of the vibration element, the vibration method further includes: calculating a weighted index based on a distance from the one of the pressing units to the vibration element and regulating the output vibration strength of the vibration element based on the weighted index.

Based on the above, in the vibration module and the vibration method of this invention, when a user touches one of the pressing units, a distance from the touched pressing unit to the vibration element and a weighted index can be calculated, such that the modulation control unit can regulate the output vibration strength of the vibration element based on the weighted index.

It is to be understood that both the foregoing general descriptions and the following detailed embodiments are exemplary and are, together with the accompanying drawings, intended to provide further explanation of technical features and advantages of the invention.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a schematic cross-view illustrating a vibration module according to an embodiment of the invention.

FIG. 2 is a schematic view showing that the vibration module depicted in FIG. 1 is disposed in an electronic device.

FIG. 3 is a flow chart illustrating a vibration method according to an embodiment of the invention.

FIG. 4 is a flow chart illustrating a vibration method according to another embodiment of the invention.

### DESCRIPTION OF EMBODIMENTS

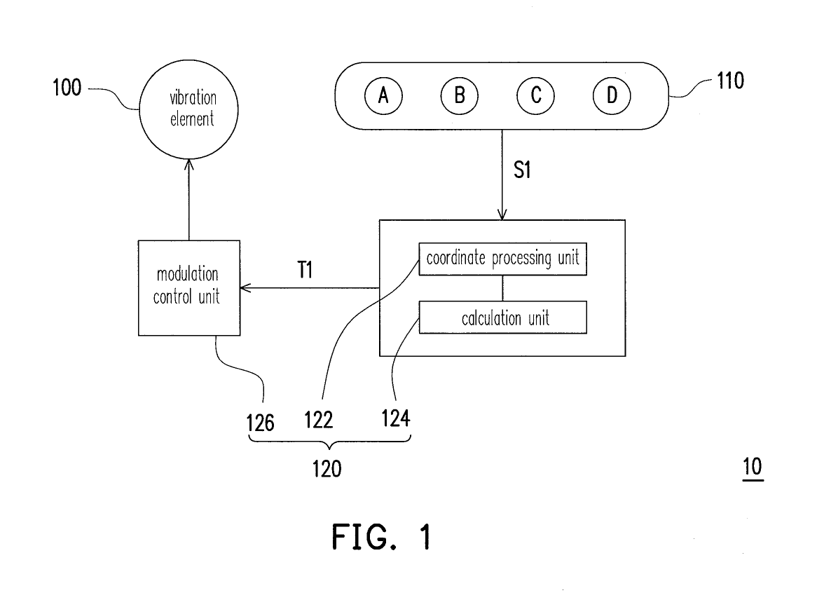

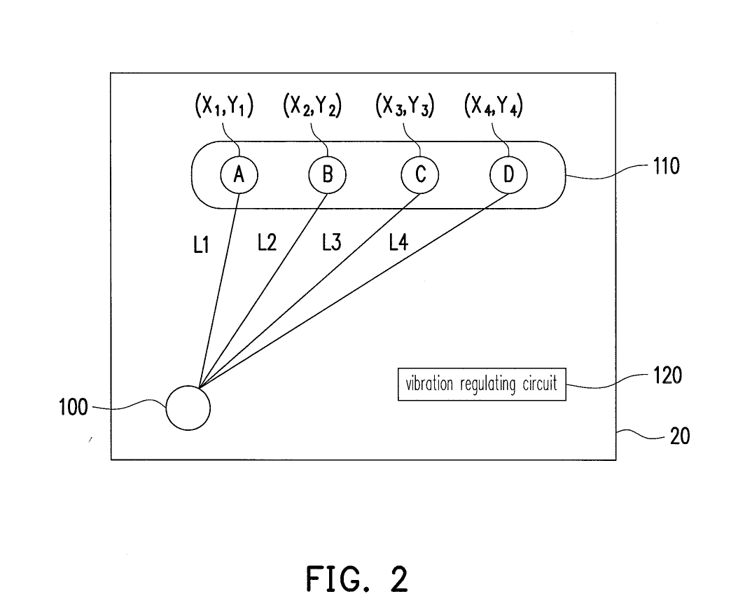

FIG. 1 is a schematic cross-view illustrating a vibration module according to an embodiment of the invention. FIG. 2 is a schematic view showing that the vibration module depicted in FIG. 1 is disposed in an electronic device.

As shown in FIG. 1 and FIG. 2, a vibration module 10 includes a vibration element 100, a plurality of pressing units A-D, and a vibration regulating circuit 120. The pressing units A-D are, for instance, disposed in a touch-sensing region 110 of an electronic device 20. Besides, the pressing units A-D are physical keys on a keyboard of a notebook computer, or electronic virtual keys on a touch-sensing display panel, and so forth, for example. The vibration regulating circuit 120 is disposed in the electronic device 20 and coupled to the vibration element 100 and the pressing units A-D. With reference to FIG. 2, a distance from each of the pressing units A-D individually having a coordinate (Xi, Yi) to the vibration element 100 is L1, L2, L3, and L4, respectively, wherein i=1˜4, and L1<L2<L3<L4. In a conventional vibration module, the distance L4 from the pressing unit D to the vibration element 100 is relatively far, and thus the user is rather unlikely to detect an output vibration strength of the vibration element 100. By contrast, the distance L1 from the pressing unit A to the vibration element 100 is relatively close, such that the user is apt to detect the output vibration strength of the vibration element 100. In this invention, the vibration regulating circuit 120 is used to regulate the output vibration strength of the vibration element 100.

As shown in FIG. 1, the vibration regulating circuit 120 can include a coordinate processing unit 122, a calculation unit 124, and a modulation control unit 126. The coordinate processing unit 122 is disposed in the electronic device 20 and receives a coordinate signal Si output by one of the pressing units A-D. The calculation unit 124 is coupled to the coordinate processing unit 122, and the calculation unit 124 calculates a weighted index T1 based on a distance from the one of the pressing units A-D to the vibration element 100. For instance, when a user touches one of the pressing units, the calculation unit 124 calculates a distance between the one of the pressing units A-D and the vibration element 100, so as to obtain the weighted index T1 based on the distance. The weighted index T1 is represented as a percentage. The farther the distance, the greater the weighted index T1; the closer the distance, the smaller the weighted index T1. For example, when the distance is L4, the weighted index T1 is 100%; when the distance is L3, the weighted index is 90%; when the distance is L2, the weighted index is 80%; when the distance is L1, the weighted index is 70%. Namely, when the distance decreases, the weighted index T1 decreases. The weighted index T1 can be set as a custom value and stored in the calculation unit 124 or in other memories, which is not limited in this invention.

Certainly, in a linear-index model, the weighted index T1 can be calculated below. For example, given that the distance is L4, the weighted index T1 is 100%; given that the distance is L3, the weighted index is L3/L4*100%; given that the distance is L2, the weighted index is L2/L4*100%; given that the distance is L1, the weighted index is L1/L4*100%. The calculated weighted index can be temporarily stored in the calculation unit 124 or other memories, which is not limited in this invention.

On the other hand, the modulation control unit 126 is disposed in the electronic device 20 and coupled to the calculation unit 124 and the vibration element 100. The modulation control unit 126 receives the weighted index T1 and regulates the output vibration strength of the vibration element 100 based on the weighted index T1. The larger the weighted index T1, the greater the output vibration strength of the vibration element 100; the smaller the weighted index T1, the less the output vibration strength of the vibration element 100. Thereby, when the user touches any of the pressing units A-D, even though the distance from each of the pressing units A-D to the vibration element 100 is different, on the user end, the degrees of vibration are approximately the same.

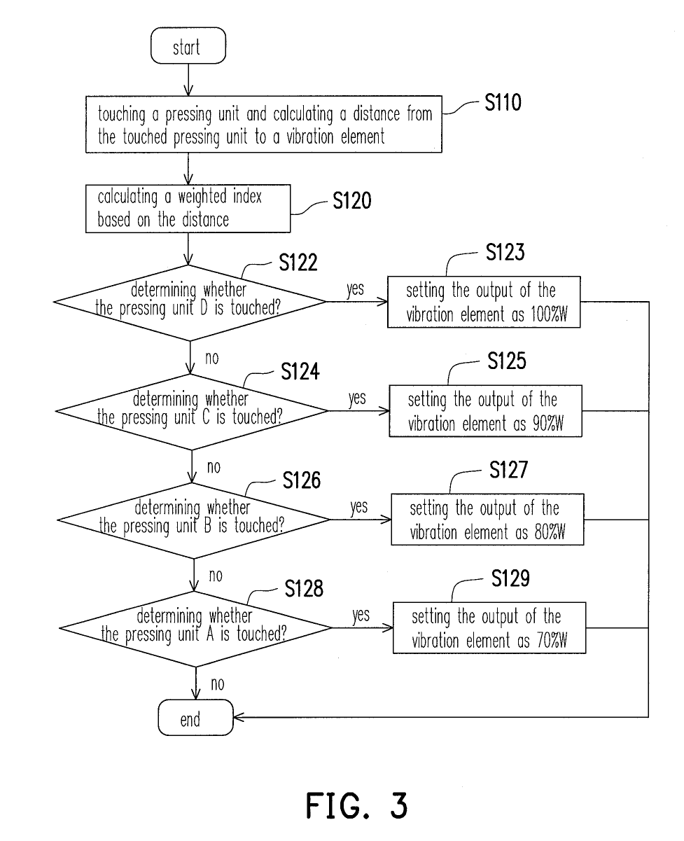

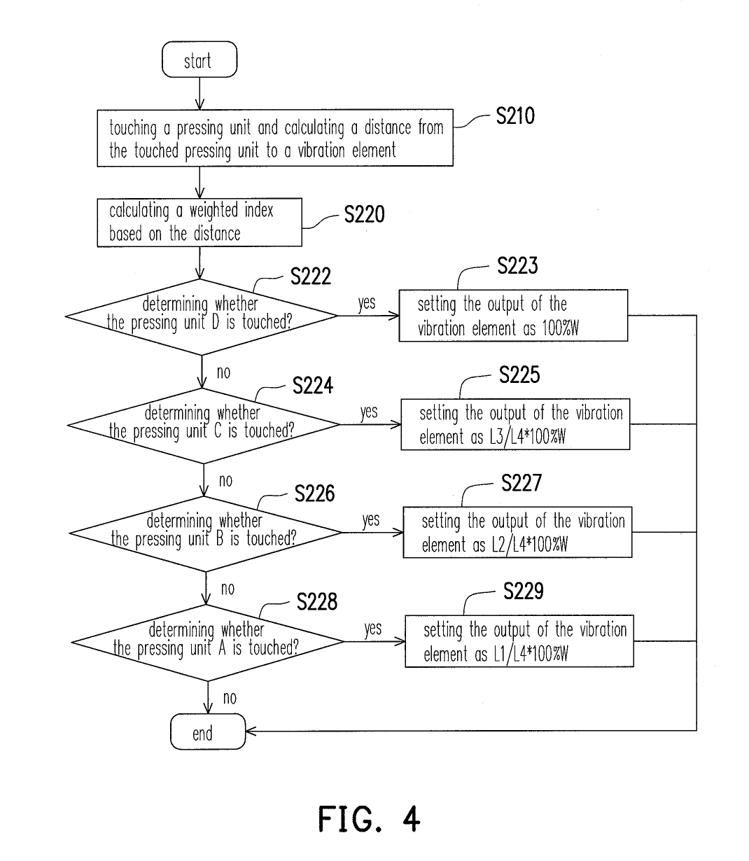

FIG. 3 is a flow chart illustrating a vibration method according to an embodiment of the invention. FIG. 4 is a flow chart illustrating a vibration method according to another embodiment of the invention. With reference to FIG. 1 to FIG. 3, in step S110, any of the pressing units A-D is touched, and a distance from the touched one of the pressing units A-D to the vibration element 100 is calculated. In step S120, the weighted index is calculated based on the distance. With reference to FIG. 2, the distance from each of the pressing units A-D individually having a coordinate (Xi, Yi) to the vibration element 100 is L1, L2, L3, and L4, respectively, wherein i=1˜4, and L1<L2<L3<L4. When a user touches any of the pressing units A-D, the calculation unit 124 calculates the distance between the touched pressing unit and the vibration element 100, so as to obtain the weighted index T1 based on the distance. The weighted index T1 is represented as a percentage. The farther the distance, the greater the weighted index T1; the closer the distance, the smaller the weighted index T1. In step S122 to step S123, when the pressing unit D is touched, the distance is L4, the weighted index is 100%, and the output vibration strength of the vibration element 100 is set as 100% W. In step S124 to step S125, when the pressing unit C is touched, the distance is L3, the weighted index is 90%, and the output vibration strength of the vibration element 100 is set as 90% W. In step S126 to step S127, when the pressing unit B is touched, the distance is L2, the weighted index is 80%, and the output vibration strength of the vibration element 100 is set as 80% W. In step S128 to step S129, when the pressing unit A is touched, the distance is L1, the weighted index is 70%, and the output vibration strength of the vibration element 100 is set as 70% W. Namely, the output vibration strength of the vibration element 100 increases together with the increase in the weighted index T1.

In another embodiment depicted in FIG. 4, the weighted index is calculated based on a linear-index model. With reference to FIG. 1, FIG. 2, and FIG. 4, in step S210, any of the pressing units A-D is touched, and a distance from the touched one of the pressing units A-D to the vibration element 100 is calculated. In step S220, the weighted index T1 is calculated based on the distance. In this embodiment, when a user touches any of the pressing units A-D, the calculation unit 124 calculates the distance between the touched pressing unit and the vibration element 100, so as to obtain the weighted index T1 based on the distance. The weighted index T1 is represented as a percentage. The farther the distance, the greater the weighted index T1; the closer the distance, the smaller the weighted index T1. In step S222 to step S223, when the pressing unit D is touched, the distance is L4, the weighted index is 100%, and the output vibration strength of the vibration element 100 is set as 100% W. In step S224 to step S225, when the pressing unit C is touched, the distance is L3, the weighted index is L3/L4*100%, and the output vibration strength of the vibration element 100 is set as L3/L4*100% W. In step S226 to step S227, when the pressing unit B is touched, the distance is L2, the weighted index is L2/L4*100%, and the output vibration strength of the vibration element 100 is set as L2/L4*100% W. In step S228 to step S229, when the pressing unit A is touched, the distance is L1, the weighted index is L1/L4*100%, and the output vibration strength of the vibration element 100 is set as L1/L4*100% W. Namely, the output vibration strength of the vibration element 100 increases together with the increase in the weighted index T1.

In light of the foregoing, in the vibration module and the vibration method of this invention, when a user touches one of the pressing units, and the distance from each of the pressing units to the vibration element is different, the distance from the touched pressing unit to the vibration element and a weighted index can be calculated, and thereby the output vibration strength of the vibration element can be regulated based on the weighted index. Hence, even though the distance from each of the pressing units to the vibration element is different, on the user end, the degrees of vibration are approximately the same.

It will be apparent to those skilled in the art that various modifications and variations can be made to the structure of the invention without departing from the scope or spirit of the invention. In view of the foregoing, it is intended that the invention cover modifications and variations of this invention provided they fall within the scope of the following claims and their equivalents.

What is claimed is:

1. A vibration module suitable for an electronic device, the vibration module comprising:
a vibration element;
a plurality of pressing units disposed on the electronic device; and
a vibration regulating circuit disposed in the electronic device and coupled to the vibration element and the pressing units, wherein the vibration regulating circuit calculates a distance between each of the pressing units and the vibration element and regulates an output vibration strength of the vibration element based on the distance.

2. The vibration module as claimed in claim 1, the vibration regulating circuit comprising:
a coordinate processing unit disposed in the electronic device and receiving a coordinate signal output by one of the pressing units;
a calculation unit coupled to the coordinate processing unit, the calculation unit calculating a weighted index based on a distance from the one of the pressing units to the vibration element;
a modulation control unit disposed in the electronic device and coupled to the calculation unit and the vibration element, the modulation control unit receiving the weighted index and regulating the output vibration strength of the vibration element based on the weighted index.

3. The vibration module as claimed in claim 2, wherein the weighted index decreases when the distance from the one of the pressing units to the vibration element decreases.

4. The vibration module as claimed in claim 2, wherein the weighted index is represented as a percentage.

5. The vibration module as claimed in claim 2, wherein the weighted index is stored in the calculation unit.

6. The vibration module as claimed in claim 2, wherein the output vibration strength of the vibration element increases when the weighted index increases.

7. The vibration module as claimed in claim 1, wherein the electronic device has a keyboard, and the pressing units are disposed on the keyboard.

8. The vibration module as claimed in claim 7, wherein the pressing units comprise a plurality of keys.

9. A vibration method suitable for an electronic device having a vibration element and a plurality of pressing units, the vibration method comprising:
touching one of the pressing units;
calculating a distance between the touched one of the pressing units and the vibration element; and
regulating an output vibration strength of the vibration element based on the distance.

10. The vibration method as claimed in claim 9, further comprising receiving a coordinate signal output by one of the pressing units in the step of touching one of the pressing units.

11. The vibration method as claimed in claim 10, in the step of regulating the output vibration strength of the vibration element, further comprising:
calculating a weighted index based on a distance from the one of the pressing units to the vibration element; and
regulating the output vibration strength of the vibration element based on the weighted index.

12. The vibration method as claimed in claim 11, wherein the weighted index decreases when the distance from the one of the pressing units to the vibration element decreases.

13. The vibration method as claimed in claim 11, wherein the weighted index is represented as a percentage.

14. The vibration method as claimed in claim 11, wherein the output vibration strength of the vibration element increases when the weighted index increases.
